(19) United States
(12) Patent Application Publication
(10) Pub. No.: US 2007/0048454 A1
(43) Pub. Date: Mar. 1, 2007

(54) Method for manufacturing a mold core

(75) Inventors: Ga-Lane Chen, Fremont, CA (US); Shih-Che Chien, Tu-Cheng (TW); Shih-Chieh Yen, Tu-Cheng (TW)

Correspondence Address: PCE INDUSTRY, INC.;ATT. CHENG-JU CHIANG JEFFREY T. KNAPP, 458 E. LAMBERT ROAD, FULLERTON, CA, 92835, US

(73) Assignee: HON HAI Precision Industry CO., LTD., Tu-Cheng City (TW)

(21) Appl. No.: 11/478,414

(22) Filed: Jun. 28, 2006

(30) Foreign Application Priority Data
Aug. 26, 2005 (CN) 200510036921.4

(51) Int. Cl. B01J 19/08; B28B 7/38

(52) U.S. Cl. 427/524; 427/133; 427/560

(57) ABSTRACT

An exemplary method for manufacturing a mold core includes steps of: providing a mold core preform having a molding surface; ultrasonically cleaning the molding surface of the mold core preform; cleansing the molding surface of the mold core preform using plasma; forming a silicon carbide film on the molding surface of the mold core perform using a sputtering process; and forming a diamond-like carbon film on the silicon carbide film using a sputtering process. The mold core made by the method has excellent hardness, compressive strength, and easy separability, low manufacturing and replacement cost.

### TECHNICAL FIELD

The present invention generally relates to a method for manufacturing a mold core for press-molding glass optical articles with high quality.

### BACKGROUND

At present, molds are widely used for manufacturing glass optical articles, plastic articles, industrial parts, etc. Especially, with the development of the digital cameras, video recorders, compact disc players and other optical systems, glass optical articles, such as aspheric lenses, ball-shaped lenses and prisms are in increasing demand. Generally, these glass optical articles and other optical products are made through a direct press-molding process, as this is a high efficiency process.

A mold core is one of the most important parts of a mold. During the press-molding process, the raw material is likely to adhere to a molding surface of the mold core at high temperature. In addition, the molding surface is subjected to a large pressure during press-molding, which will damage the mold core. Thus the mold core should have characteristics such as excellent hardness, high heat resistance and wear resistance, high compressive strength, easy separability, etc.

Therefore, it is desirable to form a protective film on the molding surface of the mold core to improve the quality and durability of the molding surface. One objective of the additional protective film is to avoid the mold adhering to the molding material. Another objective is to prevent the mold substrate material from deteriorating at high temperature in air.

A variety of materials may be applied for constituting the protective film. For example, inert metals are often used because of their resistance to oxidation and high level of smoothness. However, inert metals are expensive and difficult to replace after damage.

What is needed, therefore, is a method for manufacturing a mold core with hardness, compressive strength, easy separability.

### SUMMARY

One embodiment of the invention provides a method for manufacturing the mold core. The method includes steps of: providing a mold core preform having a molding surface, ultrasonically cleaning the molding surface of the mold core preform; cleansing the molding surface of the mold core preform using plasma; forming a silicon carbide film on the molding surface of the mold core preform using a sputtering process; and forming a diamond-like carbon film on the silicon carbide film also using a sputtering process.

### BRIEF DESCRIPTION OF THE DRAWINGS

Many aspects of the present method can be better understood with reference to the following drawings. The components in the drawings are not necessarily drawn to scale, the emphasis instead being placed upon clearly illustrating the principles of the present method. Moreover, in the drawings, like reference numerals designate corresponding parts throughout the several views.

FIG. 1 is a schematic, cross-sectional view of a mold in accordance with a preferred embodiment;

FIG. 2 is a flow chart of a method for manufacturing the mold core in accordance with the preferred embodiment;

FIG. 3 is a scanning electron microscope (SEM) image of a surface center of a mold core after press-molding test; and

FIG. 4 is another scanning electron microscope (SEM) image of a surface center of a mold core after press-molding test.

### DETAILED DESCRIPTION OF PREFERRED EMBODIMENTS

Embodiments of the present method will now be described in detail below and with reference to the drawings.

Referring to FIG. 1, a mold 99 having a mold core 100 according to an exemplary embodiment is shown. The mole core 100 includes a main body 10, a diamond-like carbon film 30, and a silicon carbide film 20 sandwiched between the main body 10 and the diamond-like carbon film 30.

The main body 10 defines a molding surface 12. The molding surface 12 has a shape conforming to that of the articles to be produced. The silicon carbide film 20 is formed on the molding surface 12 of the main body 10. The main body 10 is generally made of material selected from a group consisting of tungsten carbide and silicon nitride, and is more preferably made of tungsten carbide.

The diamond-like carbon film 30 serves as a protective layer. In the preferred embodiment, the diamond-like carbon film 30 has a thickness in a range from 5 nanometers to 20 nanometers.

The diamond-like carbon film is suitable as wear resistant coatings because of its hardness, smoothness, electrical insulation, low reactivity, optical transparency, and durability However, one of the main problems is high internal stress levels in the diamond-like carbon film. This commonly leads to poor adhesion that restricts the application of diamond-like carbon film. So, a method of overcoming the problem is forming an intermediate layer to improve adhesion.

The silicon carbide film 20 serves as an intermediate transition layer which is sandwiched between the molding surface 12 of the main body 10 and the diamond-like carbon film 30. The silicon carbide film 20 is a material with high adhesion to the main body 10 and to the diamond-like carbon film 30. Advantageously, thickness of the silicon carbide film 20 is in a range from 50 nanometers to 200 nanometers.

In the present embodiment, the silicon carbide film 20 can adhere closely to the main body 10 comprised of tungsten carbide. This will be explained as follows. First, heated tungsten carbide and heated silicon carbide have similar ductility. Second, covalence bonding with carbon in tungsten carbide and silicon in silicon carbide is formed. Additionally, performance of silicon carbide in high temperature and high radiation conditions will retain enable the diamond-like carbon film 30 and the mold core 100 to perform well in extreme conditions.

Press-molding of an optical preform 40 can be performed on the diamond-like carbon film 30 so as to make optical articles.

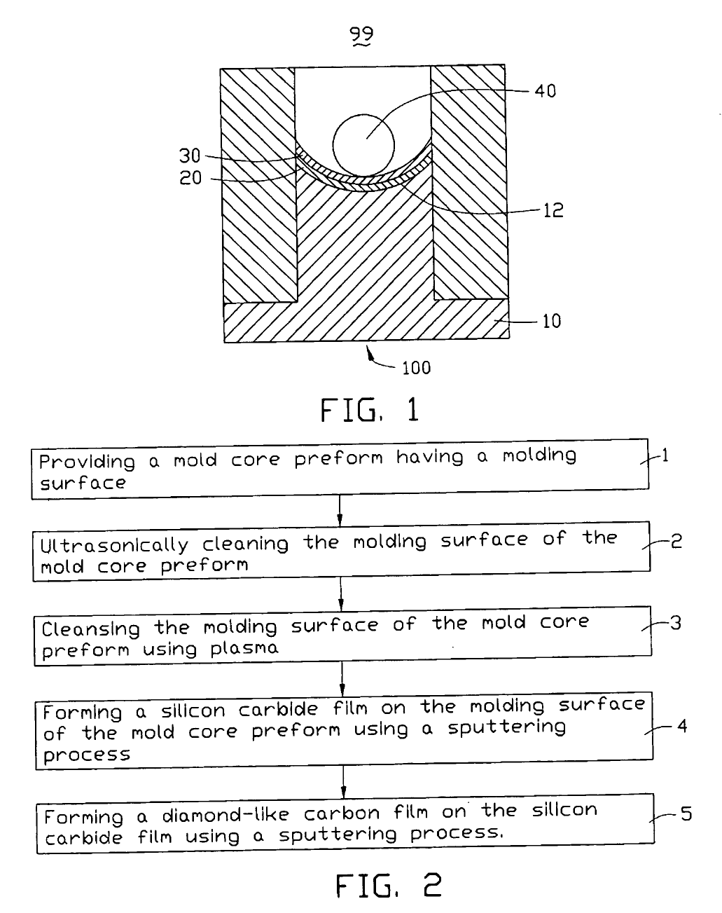

Referring to FIG. 2, a method for manufacturing the mold core 100 is shown. The method includes steps of:

step 1: providing a mold core preform (i.e the main body) 10 having a molding surface 12;

step 2: ultrasonically cleaning the molding surface 12 of the mold core preform 10;

step 3: cleansing the molding surface 12 of the mold core preform 10 using plasma;

step 4: forming a silicon carbide film 20 on the molding surface 12 of the mold core preform 10 using a sputtering process; and

step 5: forming a diamond-like carbon film 30 on the silicon carbide film 20 using a sputtering process.

The following embodiment is provided to describe the method for manufacturing the mold core 100 in detail.

In the step 1, a mold core preform 10 having a molding surface 12 is provided The molding surface 12 has a shape conforming to that of the articles. The mold core preform 10 is preferably made of material selected from a group consisting of tungsten carbide and silicon nitride, and is more preferably made of tungsten carbide.

Ultrasonic cleaning is most successful applied in the removing insoluble particulate contamination from surfaces. In the step 2, ultrasonic cleaning is used for cleaning the molding surface 12 of the mold core 100. Contamination on the molding surface 12 that is soluble or emulsifiable can usually be removed by means of ultrasonic cleaning in suitable solvents or detergent solutions. For example, cleaning the molding surface 12 of the mold core preform 10 can be performed in an acetone-containing solution for a time period of about 20 minutes in an ultrasonic cleaner.

Generally, ultrasonic cleaning of the molding surface 12 of the mold core preform 10 in an ethanol-containing solution is also performed for a time period of about 10 minutes after ultrasonically cleaning the molding surface 12 of the mold core preform 10 in the acetone-containing solution.

Then, drying the molding surface 12 of the mold core preform 10 by means of a nitrogen gas spray.

After the ultrasonically cleaning, in step 3 the molding surface 12 of the mold core preform 10 is cleansed using plasma.

Cleansing using plasma is generally used to remove oxides and reducible compounds from surfaces without damage to clean surfaces prior to coating. The process of plasma cleaning is performed in a magnetron sputtering system. A gas introduced into the magnetron sputtering system can be selected from a group consisting of argon, nitrogen, hydrogen, oxygen. Plasma generated by the gas due to high electrical energy is used to react with oxides and reducible compounds on surfaces.

In the preferred embodiment, the gas introduced into the chamber of the magnetron sputtering system is argon. Cleansing using plasma is performed at a pressure in a range from 2 millitorrs to 7 millitorrs and at a bias voltage in a range from 100 volts to 300 volts. Argon plasma reacts with oxides and reducible compounds on the molding surface 12. As a result, oxides and reducible compounds on the molding surface 12 can be removed effectively. Cleansing the molding surface 12 of the mold core preform 10 using plasma is performed for a time period of at least 3 minutes.

Thus, because of ultrasonically cleaning and cleansing using plasma of the molding surface 12 of the mold core preform 10 the adhesion between the molding surface 12 and the silicon carbide film 20 can be enhanced. In later steps, the silicon carbide film 20 and the diamond-like carbon film 30 with good adhesion can be formed on the clean molding surface 12 through a sputtering process.

In the step 4, a silicon carbide film 20 is formed on the molding surface 12 of the mold core preform 10 by sputtering a silicon carbide target in a magnetron sputtering system. Introducing an inert gas selected from a group consisting of argon, krypton, xenon, and radon into a sputtering chamber of the magnetron sputtering system. In the preferred embodiment, the argon is preferably introduced into the sputtering chamber. The formation of the silicon carbide film is performed at a pressure in a range from 5 millitorrs to 40 millitorrs and at a bias voltage in a range from 0 volts to −5 volts. A sputtering thickness of the silicon carbide film 20 can be in a range from 50 nanometers to 200 nanometers.

In the step 5, the diamond-like carbon film 30 is formed on the silicon carbide film 20 by sputtering a carbon target in a magnetron sputtering system. The inert gas selected from a group consisting of argon, krypton, xenon, and radon is introduced into the sputtering chamber of the magnetron sputtering system. In the preferred embodiment, the argon is preferably introduced into the sputtering chamber. The formation of the silicon carbide film 20 is performed at a pressure in a range from 5 millitorrs to 40 millitorrs and at a bias voltage in a range from 0 volts to −5 volts. A sputtering thickness of the diamond-like carbon film 30 is in a range from 5 nanometers to 20 nanometers.

The mold core 100 made by means of the above-described method has satisfying performance such as excellent hardness, high compressive strength, easy separability, and low manufacturing cost.

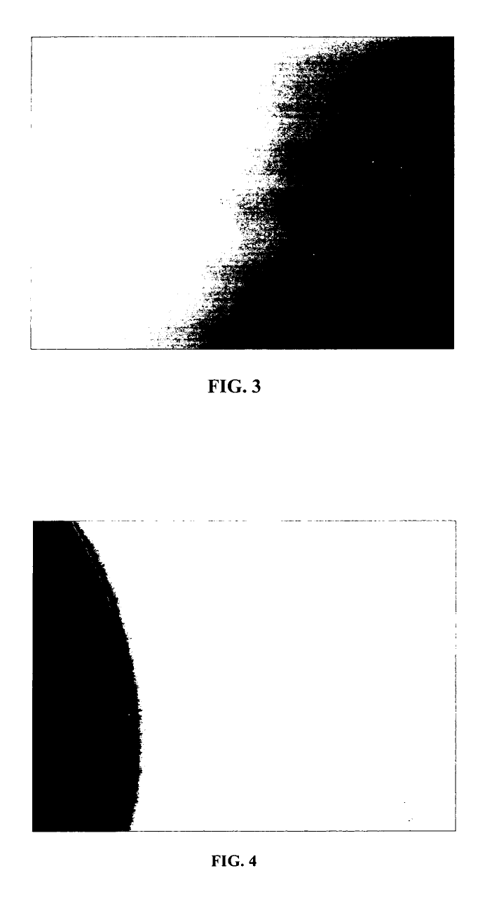

Referring to FIG. 3 and FIG. 4, scanning electron microscope (SEM) images of a surface center of the mold core 100 were taken after a press-molding test. In the test, the mold core 100 was used to press-mold a glass blank 40. It was found that the surface of the mold core 100 had good surface properties such as a high level of smoothness after press-molding. The surface roughness (Ra) of the mold core 100 is less than 20 nanometers. In the meantime, the silicon carbide film 20 and the diamond-like carbon film 30 on the mold core 100 suffered little or no damage.

While certain embodiments of the present invention have been described and exemplified above, various other embodiments will be apparent to those skilled in the art from the foregoing disclosure. The present invention is, therefore, not limited to the particular embodiments described and exemplified but is capable of considerable variation and modification without departure from the scope of the appended claims.

We claim:

1. A method for manufacturing a mold core comprising steps of:
providing a mold core preform having a molding surface;
ultrasonically cleaning the molding surface of the mold core preform;
cleansing the molding surface of the mold core preform using plasma;
forming a silicon carbide film on the molding surface of the mold core perform using a sputtering process; and
forming a diamond-like carbon film on the silicon carbide film using a sputtering process.

2. The method as claimed in claim 1, wherein the mold core preform is made from a material selected from a group consisting of tungsten carbide and silicon nitride.

3. The method as claimed in claim 1, wherein the step of ultrasonically cleaning is performed in an acetone-containing solution.

4. The method as claimed in claim 3, wherein the step of ultrasonically cleaning is performed for a time period of about 20 minutes.

5. The method as claimed in claim 3, further comprising the step of ultrasonically cleaning the molding surface of the mold core perform in an ethanol-containing solution after the step of ultrasonically cleaning the molding surface of the mold core perform in the acetone-containing solution is performed.

6. The method as claimed in claim 5, wherein the step of ultrasonically cleaning the molding surface of the mold core perform in the ethanol-containing solution is performed for a time period of about 10 minutes.

7. The method as claimed in claim 1, further comprising the step of drying the molding surface of the mold core preform by means of a nitrogen gas spray after the ultrasonic cleaning step is performed.

8. The method as claimed in claim 1, wherein the step of cleansing the molding surface of the mold core preform using plasma is performed for a time period of at least 3 minutes.

9. The method as claimed in claim 1, wherein the plasma used in the step of cleansing the molding surface of the mold core preform undergoes a bias voltage in a range from 100 volts to 300 volts.

10. The method as claimed in claim 1, wherein the step of cleansing the molding surface of the mold core preform is performed at a pressure in a range from 2 millitorrs to 7 millitorrs.

11. The method as claimed in claim 1, wherein the plasma for the step of cleansing is generated from a gas selected from the group consisting of argon, nitrogen, hydrogen, and oxygen.

12. The method as claimed in claim 1, wherein the silicon carbide film has a thickness in a range from 50 nanometers to 200 nanometers.

13. The method as claimed in claim 1, wherein the diamond-like carbon film has a thickness in a range from 50 nanometers to 200 nanometers.

14. The method as claimed in claim 1, wherein the silicon carbide film and the diamond-like carbon film are formed using a sputtering process which is performed at a bias voltage in a range from above 0 volts to −5 volts.

15. The method as claimed in claim 1, wherein the silicon carbide film and the diamond-like carbon film are formed at a pressure in a range from 5 millitorrs to 40 millitorrs.
